(19) United States
(12) Patent Application Publication
(10) Pub. No.: US 2021/0355028 A1
(43) Pub. Date: Nov. 18, 2021

(54) Mineralizer Composition and Pidgeon Silicothermic Process for Smelting Magnesium

(71) Applicant: North Minzu University, Yinchuan (CN)

(72) Inventors: Lan'er Wu, Yinchuan (CN); Fenglan Han, Yinchuan (CN)

(21) Appl. No.: 16/876,406

(22) Filed: May 18, 2020

(51) Int. Cl. C04B 5/06; C01F 11/22; C01B 35/06; C01B 35/10; C01B 35/12; C22B 5/04; C22B 26/22; C22B 1/24

(52) U.S. Cl. CPC C04B 5/06; C01F 11/22; C01B 35/061; C01B 35/1054; C22B 1/24; C01B 35/126; C01B 35/128; C22B 5/04; C22B 26/22; C01B 35/121

(57) ABSTRACT

A mineralizer composition for Pidgeon silicothermic process for smelting magnesium consists of fluorite and a boron-containing compound. Amounts of the fluorite and the boron-containing compound meet the following equation:

M_{fluo-original}=(1−x)M_{fluo}+(m)(x)M_{B},

where, M_{fluo-original} is a mass of the fluorite required in a conventional Pidgeon silicothermic process in which no boron-containing compound is introduced to replace a fraction or all of the total fluorite, M_{fluo} is a mass of the fluorite in the composition, M_{B} is a mass of the boron-containing compound in the composition, 0.5≤x≤1, and 2≤m≤8. A Pidgeon silicothermic process for smelting magnesium is also provided, which employs the mineralizer composition. The composition and process of the disclosure enable reduction and even avoidance of dust pollution caused by fluorite-containing magnesium slag.

### TECHNICAL FIELD

The present disclosure relates generally to a Pidgeon silicothermic process for smelting magnesium, and in particular to a mineralizer composition and a Pidgeon silicothermic process for smelting magnesium that allows reduction and even avoidance of dust pollution caused by fluorite-containing magnesium slag.

### BACKGROUND

Magnesium metal and magnesium alloy have been the focus of study in recent years, and are widely used in the fields of aerospace, automobile, motorcycle, information technology (IT) products, medicine and others.

Magnesium metal can be produced by an electrolytic process in which magnesium chloride is electrolyzed to produce the magnesium metal, or by a silicothermic reduction process in which dolime is reduced to produce the magnesium. The electrolytic process is very expensive owing to its high power consumption. Therefore, the silicothermic reduction process is commonly used to mass-produce the magnesium.

The Canadian Professors Jiang Fashi and L. M. Pidgeon developed a process for producing magnesium by thermal reduction of magnesium containing material with ferrosilicon in 1941 (so-called Pidgeon process). According to this process, as is well known, dolomite, as the magnesium containing material, is firstly calcined to give calcined dolomite or dolime (MgO/CaO). The calcined dolomite is then ground and mixed with ferrosilicon powder as a reducing agent and fluorite powder as a mineralizer in a certain ratio followed by briquetting of the mixture. Briquettes so obtained are placed into a reduction retort, where raw magnesium is produced from the briquettes at a temperature of around 1200° C. under about 13 Pa. After refining, ingot casting and surface treatment, the raw magnesium is changed into pure magnesium (magnesium ingot).

A basic reaction involved in this process is:

Si (s)+2 MgO (s)→SiO₂ (s)+2 Mg (g).

Silicon (Si) and magnesia (MgO) react to produce silica (SiO₂) and the magnesium (Mg). This process usually yields 6 to 8 tons magnesium slag for every ton of magnesium produced. It should be noted that the fluorite is used as a mineralizer to promote the reaction instead of directly participating in it. So, the fluorite will be left in the slag, which may impose two major threats to the environment: 1) dust pollution; and 2) water, soil and air pollution caused by fluoride in the fluorite, for example, calcium fluoride (CaF₂).

Assuming 6.5 tons slag for every ton of the magnesium, for example, over four million tons of the slag can be produced annually in China, causing occupation of a lot of land and spread of a large amount of dust into the environment, which is hazardous to human health. Therefore, it is desired to reduce dust pollution caused by the fluorite-containing magnesium slag in powder form.

### SUMMARY

The present disclosure is directed to a mineralizer composition and a Pidgeon silicothermic process for smelting magnesium that allows reduction and even avoidance of dust pollution caused by the fluorite-containing magnesium slag in powder form.

In one aspect of the disclosure, a mineralizer composition for Pidgeon silicothermic process for smelting magnesium consists of fluorite and a boron-containing compound, wherein amounts of the fluorite and the boron-containing compound meet the following equation:

M_{fluo-original}=(1−x)M_{fluo}+(m)(x)M_{B},

where M_{fluo-original} is a mass of the fluorite required in a conventional Pidgeon silicothermic process in which no boron-containing compound is introduced to replace a fraction or all of the total fluorite (hereinafter referred to as the original fluorite), M_{fluo} is a mass of the fluorite in the composition, M_{B} is a mass of the boron-containing compound in the composition, 0.5≤x=1, and 2≤m≤8, and preferably, 0.5≤x<1, and 4≤m≤8, and more preferably, 0.5<x<1.

It has surprisingly been found that, when the composition is used in the Pidgeon process, the boron-containing compound therein acts as not only a mineralizer, but also a stabilizer which enables the magnesium slag produced by the Pidgeon process to be in a lump form instead of the powder form as it prevents volume expansion of dicalcium silicate (CaO.SiO₂, C₂S) in the slag resulted from beta-to-gamma phase transformation during a cooling process and thus prevents the slag from dusting.

The boron-containing compound in the composition enables a significantly reduced amount of CaF₂ (main compound in the fluorite) to be left in the slag and enables reduction of the fluorite-related pollution to the environment.

It can be apparent from the above equation that the total amount of the mineralizer consisting of the composition, that is required to be used in the Pidgeon silicothermic process, can be significantly reduced compared with the amount of the original fluorite. Although the price of the boron-containing compound is higher than that of the fluorite, the amount of the boron-containing compound required is less than that of the fluorite. Therefore, the cost of the mineralizer composition according to the disclosure is comparable with or even lower than that of the original fluorite.

In an embodiment in which x=1, the composition contains no fluorite and consists of the boron-containing compound only. In this case, the amount of the boron-containing compound required is in a range of one eighth to one half of the original fluorite amount.

It has also been found that when the value of x is around 0.5, although there will still be a high amount of CaF₂ to be left in the slag, the amount of the boron-containing compound (m=2˜8) is high enough to prevent volume expansion of C₂S in the slag resulted from beta-to-gamma phase transformation during a cooling process. So, dust pollution caused by fluoride in the fluorite can be avoided.

The factor m may be variable depending on different boron-containing compounds according to their ability to prevent volume expansion of C₂S in the slag resulted from beta-to-gamma phase transformation during a cooling process.

In some embodiments, the boron-containing compound may be selected from a group consisting of boric acid, borate, boric anhydride, lithium metaborate, sodium metaborate, sodium tetraborate, potassium metaborate, magnesium metaborate, calcium metaborate, barium metaborate, lead borate, disodium octaborate tetrahydrate and a combination thereof. Preferably, the boron-containing compound may be boric acid or borate in powder form.

In an embodiment, the boron-containing compound may be applied with the fluorite together or separately with or without a carrier. The carrier may have a framework structure, which may be made of a material selected from a group consisting of carbon and carbon-containing material, boron-containing material, silicon-containing material and a combination thereof.

In another aspect of the disclosure, a Pidgeon silicothermic process for smelting magnesium comprises providing the mineralizer composition according to the first aspect of the disclosure.

In yet another aspect of the disclosure, a Pidgeon silicothermic process for smelting magnesium comprises: grinding and mixing calcined dolomite, ferrosilicon as a reducing agent, and the mineralizer composition according to the first aspect of the disclosure; briquetting the mixture so obtained; placing the briquettes so obtained into a reduction retort followed by heating the briquettes to a temperature of 1120 to 1200° C. and evacuating the retort to 10 to 20 Pa; subjecting the briquettes to said temperature for 6 to 10 h; and collecting raw magnesium after cooling; wherein, the briquette comprises 12-18 wt % of the ferrosilicon, 0.2-3.5 wt % of the mineralizer composition, and a balance of calcined dolomite.

Apparently, the process according to the disclosure does not require modification to the devices used in and process conditions of the conventional Pidgeon process.

In addition, the boron-containing compound in the mineralizer composition prevents volume expansion of C₂S in the slag produced by the process resulted from beta-to-gamma phase transformation during a cooling process, as described in the first aspect of the disclosure. This can lead to a dust-free magnesium slag, which facilitates storage, transport and further use thereof. Moreover, the magnesium slag produced by the process according to the disclosure may have a good cementitious activity.

In an embodiment, the boron-containing compound may be contained in the magnesium slag produced by the process in the form of B₂O₃, for example, in an amount of 0.2 to 1.5 wt % of the total slag, preferably 0.3 to 0.5 wt % of it.

### BRIEF DESCRIPTION OF THE DRAWINGS

FIG. 1A is a photograph depicting a magnesium slag produced in Comparative Examples A, B and C; and

FIG. 1B is a photograph depicting a magnesium slag produced in Examples I, II and III.

### DETAILED DESCRIPTION

The present disclosure will be further described in detail below with reference to examples.

### Example I and Comparative Example A

Reagents used in Example I and Comparative Example A, and amounts thereof, are listed in Table 1.

TABLE 1
Reagents and amounts thereof used in
Example I and Comparative Example A

| | Reagents | | | | | |
|---|---|---|---|---|---|---|
| | Calcined | | | Boric | | |
| | dolomite/ | Ferrosilicon/ | Fluorite/ | acid/ | | |
| | wt % | wt % | wt % | wt % | m | x |
| Example I | 82.3 | 16.9 | 0.5 | 0.3 | 8 | 0.8 |
| Comparative | 80.9 | 16.6 | 2.5 | 0 | — | — |
| Example A | | | | | | |

In both Example I and Comparative Example A, calcined dolomite, ferrosilicon, fluorite and boric acid (only fluorite in the case of the Comparative Example A) were ground and mixed, and then briquetted. The briquettes so obtained were placed into a reduction retort, where the briquettes were heated to a temperature of about 1150 to about 1250° C. The reduction retort was evacuated to 13 Pa. The briquettes in the retort were subjected to that temperature for a period. After cooling, raw magnesium was collected.

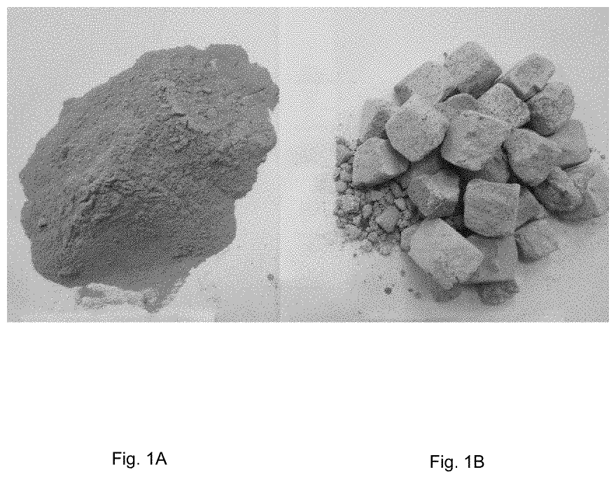

It was found that Example I provided a raw magnesium yield which was 17% higher than that of the Comparative Example A. A composition analysis showed that the two examples provided similar Mg composition, which fully met the metallurgy magnesium industry standard. It was also found that the magnesium slag produced in Example I was in lump form and the slag produced in the Comparative Example A was in powder form, as shown in FIG. 1A and FIG. 1B.

### Example II and Comparative Example B

Reagents used in Example II and Comparative Example B, and amounts thereof, are listed in Table 2.

TABLE 2
Reagents and amounts thereof used in
Example II and Comparative Example B

| | Reagents | | | | | |
|---|---|---|---|---|---|---|
| | Calcined | | | Boric | | |
| | dolomite/ | Ferrosilicon/ | Fluorite/ | acid/ | | |
| | wt % | wt % | wt % | wt % | m | x |
| Example II | 81.1 | 17.9 | 0.5 | 0.5 | 4 | 0.8 |
| Comparative | 81.0 | 16.5 | 2.5 | 0 | — | — |
| Example B | | | | | | |

In both Example II and Comparative Example B, calcined dolomite, ferrosilicon, fluorite and boric acid (only fluorite in the case of the Comparative Example B) were ground and mixed, and then briquetted. The briquettes so obtained were placed into a reduction retort, where the briquettes were heated to a temperature of about 1150 to 1250° C. The retort was evacuated as the same in Example I. The briquettes in the retort were subjected to that temperature for a period. After cooling, raw magnesium was collected.

It was found that Example II provided a raw magnesium yield which was 8% higher than that of the Comparative Example B. A composition analysis showed that the two examples provided similar Mg composition, which fully met the metallurgy magnesium industry standard. It was also found that the magnesium slag produced in Example II was in lump form and the slag produced in the Comparative Example B was in powder form, as shown in FIG. 1A and FIG. 1B.

### Example III and Comparative Example C

Reagents used in Example III and Comparative Example C, and amounts thereof, are listed in Table 3.

TABLE 3
Reagents and amounts thereof used in
Example III and Comparative Example C

| | Reagents | | | | | |
|---|---|---|---|---|---|---|
| | Calcined | | | Boric | | |
| | dolomite/ | Ferrosilicon/ | Fluorite/ | acid/ | | |
| | wt % | wt % | wt % | wt % | m | x |
| Example III | 82.5 | 17.0 | 0 | 0.5 | 5 | 1 |
| Comparative | 80.9 | 16.6 | 2.5 | 0 | — | — |
| Example C | | | | | | |

The reagents were subjected to the same process as the above examples.

It was found that Example III provided a raw magnesium yield which was 12% less than that of the Comparative Example C, possibly due to the fact that the amount of the mineralizer is too small. A composition analysis showed that the two examples provided similar Mg composition. It was also found that the magnesium slag produced in Example III was in lump form and the slag produced in the Comparative Example C was in powder form, as shown in FIG. 1A and FIG. 1B.

While the present disclosure has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art.

What is claimed is:

1. A mineralizer composition for Pidgeon silicothermic process for smelting magnesium, consisting of fluorite and a boron-containing compound;
wherein amounts of the fluorite and the boron-containing compound meet the following equation:
M_{fluo-original}=(1−x)M_{fluo}+(m)(x)M_{B},
and wherein, M_{fluo-original} is a mass of the fluorite required in a conventional Pidgeon silicothermic process in which no boron-containing compound is introduced to replace a fraction or all of the total fluorite,
M_{fluo} is a mass of the fluorite in the composition,
M_{B} is a mass of the boron-containing compound in the composition,
0.5≤x≤1, and 2≤m≤8.

2. The composition according to claim 1, wherein 0.5≤x<1.

3. The composition according to claim 2, wherein 0.5<x<1.

4. The composition according to claim 1, wherein 4≤m≤8.

5. The composition according to claim 1, wherein the boron-containing compound is selected from a group consisting of boric acid, borate, boric anhydride, lithium metaborate, sodium metaborate, sodium tetraborate, potassium metaborate, magnesium metaborate, calcium metaborate, barium metaborate, lead borate, disodium octaborate tetrahydrate and a combination thereof.

6. The composition according to claim 5, wherein the boron-containing compound is boric acid or borate in powder form.

7. A Pidgeon silicothermic process for smelting magnesium, comprising providing a mineralizer composition, the composition consisting of fluorite and a boron-containing compound;
wherein amounts of the fluorite and the boron-containing compound meet the following equation:
M_{fluo-original}=(1−x)M_{fluo}+(m)(x)M_{B},
and wherein, M_{fluo-original} is a mass of the fluorite required in a conventional Pidgeon silicothermic process in which no boron-containing compound is introduced to replace a fraction or all of the total fluorite,
M_{fluo} is a mass of the fluorite in the composition,
M_{B} is a mass of the boron-containing compound in the composition,
0.5≤x≤1, and 2≤m≤8.

8. The process according to claim 7, wherein 0.5≤x<1.

9. The process according to claim 8, wherein 0.5<x<1.

10. The process according to claim 7, wherein 4≤m≤8.

11. The process according to claim 7, wherein the boron-containing compound is selected from a group consisting of boric acid, borate, boric anhydride, lithium metaborate, sodium metaborate, sodium tetraborate, potassium metaborate, magnesium metaborate, calcium metaborate, barium metaborate, lead borate, disodium octaborate tetrahydrate and a combination thereof.

12. The process according to claim 11, wherein the boron-containing compound is boric acid or borate in powder form.

13. The process according to claim 7, wherein the boron-containing compound is contained in a magnesium slag produced by the process in an amount of 0.2 to 1.5 wt %, preferably 0.3 to 0.5 wt %.

14. A Pidgeon silicothermic process for smelting magnesium, comprising:
grinding and mixing calcined dolomite, ferrosilicon as a reducing agent, and a mineralizer composition according to claim 1;
briquetting the mixture so obtained;
placing the briquettes so obtained into a reduction retort followed by heating the briquettes to a temperature of 1120 to 1200° C. and evacuating the retort to 10 to 20 Pa;
subjecting the briquettes to said temperature for 6 to 10 h; and
collecting raw magnesium after cooling;
wherein, the briquette comprises 12-18 wt % of the ferrosilicon, 0.2-3.5 wt % of the mineralizer composition, and a balance of calcined dolomite.
